(19) United States
(12) Patent Application Publication
(10) Pub. No.: US 2008/0203920 A1
(43) Pub. Date: Aug. 28, 2008

(54) Lamp Having Molybdenum Alloy Lamp Components

(75) Inventors: Jiajun Wang, Maarheeze (NL); Hubert Menno Sasker, Nijmegen (NL); Chrysostomus Hidde Maria Maree, Maarheeze (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/914,764

(22) PCT Filed: May 9, 2006
(86) PCT No.: PCT/IB2006/051447

§ 371 Date: Nov. 19, 2007

(30) Foreign Application Priority Data
May 19, 2005 (EP) 05104272.7

(51) Int. Cl. H01J 61/36; H01J 9/28

(52) U.S. Cl. 313/634; 445/35

(57) ABSTRACT

The invention relates to a lamp (1) comprising a gastight vessel (2) embedding one or more feedthrough elements (7,8) electrically interconnecting an outer current conductor (9,10) and an inner current conductor (3,4) for operating said lamp. The feedthrough elements and/or the outer and inner current conductor are molybdenum alloy components containing at least one constituent from the group formed by rhenium and chromium in a quantity between 0.01 and 5% by weight; titanium in a quantity between 0.01 and 0.1% by weight; and aluminum, cobalt, gadolinium, hafnium, iridium, iron and zirconium in a quantity between 0.01 and 1% by weight of said alloy. The invention further relates to a method of manufacturing a lamp and a lamp component.

### FIELD OF THE INVENTION

The invention relates to a lamp having one or more molybdenum alloy lamp components. More specifically, the invention relates to a lamp, e.g. a metal halide high-intensity discharge lamp for use in car headlights, having a molybdenum alloy feedthrough, an outer current conductor and/or an inner current conductor.

### BACKGROUND OF THE INVENTION

Generally, the vessel of a metallic halide lamp is composed of a length of glass tube, with its opposite ends pinch-sealed to provide a hermetically closed discharge chamber which contains substances such as a metallic halide, xenon, and mercury. Silica glass or quartz is currently a preferred material for the vessel of a metallic halide lamp. Quartz glass has a low thermal coefficient of linear expansion, 0.5*10⁻⁶ K⁻¹. The outer current conductors of a metallic halide lamp may be made of molybdenum and the inner current conductors, i.e. the electrodes for a discharge lamp, may be made of tungsten. The thermal expansion coefficients for the molybdenum lead wires and tungsten electrodes are both significantly higher than for the quartz glass. It is therefore undesirable to bury any extended lengths of the molybdenum lead wires and the tungsten electrodes in the pinch seals by directly interconnecting them.

This difficulty has been partly overcome by interposing foils of molybdenum between electrodes and leads and by burying the molybdenum foils in the pinch seals. The molybdenum foils are less affected by the difference in thermal coefficient of linear expansion despite the numerous repetitions of expansion and contraction of the glass envelope during use of the lamp. Less relative displacement and less gap creation are known to occur between molybdenum foils and pinch seals than between molybdenum wires and pinch seals, and so are fewer cracks and consequent leakage of the gases from the discharge chamber.

Stringent requirements are imposed on the molybdenum feedthrough element and other lamp components of modern lamps. In particular, these components should have a high resistance against oxidation for parts outside the vessel and corrosion for parts inside the vessel. One of the failure mechanisms is breakage between the feedthrough element and the vessel due to aggressive corrosion by the gases within the vessel as well as by oxygen outside the lamp. Typically, molybdenum starts to oxidize at temperatures above 350° C.

Furthermore, appropriate welding properties are required for interconnection to the outer current conductors and the inner current conductors or electrodes.

U.S. Pat. No. 6,570,328 discloses an electric lamp comprising a lamp vessel and an electric element. The electric element is electrically connected to the outer side via a current feedthrough which comprises a molybdenum gauze as a metal sealing part. The risks of too strong oxidation of the metal sealing part and of excessive tensile stresses in the seal are decreased. The gauze consists of an element chosen from the group formed by molybdenum, rhenium and mixtures thereof. Advantageously, dopants in amounts up to 10% by weight are added to improve the gauze material properties. These dopants preferably comprise yttrium, hafnium, thorium and/or lanthanum.

In another approach, disclosed in e.g. DE-OS 30 06 846, a feedthrough foil (e.g. Mo or W) in the pinch seal of a metal halide-containing high-pressure mercury discharge lamp has a coating of tantalum, niobium, vanadium, chromium, zirconium, titanium, yttrium or hafnium so as to improve the gas tightness of the seal. If a part of an external current conductor situated in the pinch seal is also formed, at least at its surface, from one of these coating metals, it prevents alkali metals escaping from the filling inside the discharge vessel.

### OBJECT AND SUMMARY OF THE INVENTION

It is an object of the invention to provide a lamp having lamp components that are suitable to meet the various requirements of oxidation and corrosion resistance, have a sufficiently high ductility and are capable of being welded to other components.

The object is accomplished by a lamp comprising a gastight vessel embedding one or more feedthrough elements electrically interconnecting an outer current conductor and an inner current conductor for operating said lamp, wherein at least one of said feedthrough elements, said outer current conductor and said inner current conductor is a molybdenum alloy component containing at least one constituent from the group formed by rhenium and chromium in a quantity between 0.01 and 5% by weight; titanium in a quantity between 0.01 and 0.1% by weight; and aluminum, cobalt, gadolinium, hafnium, iridium, iron and zirconium in a quantity between 0.01 and 1% by weight of said alloy.

The inventors have found that the lamp components of molybdenum alloys having one or more selected constituents, i.e. selected metal dopes, in the specified quantities have an excellent ductility behavior while maintaining an adequate oxidation and corrosion resistance. The selected constituents and quantities, preferably rhenium, bring about an appropriate balance between mechanical properties, on the one hand, and corrosion and oxidation resistance, on the other hand, for the molybdenum alloy lamp components. The metal dopes may function as built-in getters for harmful impurities such as oxygen, carbon, and hydrogen and consequently prolong the service life of the lamp. The type of dopant depends, inter alia, on the lamp atmosphere in the vessel. The molybdenum-rhenium alloys only start oxidizing at temperatures of about 450° C., which is considerably higher than for pure molybdenum. The obtained molybdenum alloy lamp component is capable of being connected to other components by means of welding. As compared with the prior art, in which the lamp component is a feedthrough, a gauze shape or additional coating is not necessary. Moreover, the quality of the coating is difficult to control for coated feedthroughs, especially for pinch seals of quartz vessels. By employing molybdenum alloys according to the invention, oxidation protection is accomplished more reliably while providing a protection which is comparable with feedthroughs using a coating.

It should be noted that the lamp components of the invention can be used in e.g. ultrahigh pressure lamps, metal halide lamps and halogen lamps. It is noted that, apart from the claimed constituents and quantities, the molybdenum alloy lamp components typically comprise yttrium oxides or yttrium oxides and cerium oxides especially for feedthrough foils. Yttrium oxides and yttrium oxides in combination with cerium oxides improve the weldability of these foils. However, these oxides as such do not provide a sufficient corrosion resistance for adequate protection against the lamp atmosphere.

In an embodiment of the invention, the lamp component comprises a molybdenum alloy feedthrough foil as defined in claim 2 or 3. The rhenium constituent has a preferable quantity of between 0.05 and 1.5% by weight, in which case it does not cause significant solid solution hardening because of the similarity in size with the molybdenum atoms, which is important for the ductility behavior of the foil. Furthermore, rhenium does not significantly influence the lamp atmosphere.

In an embodiment of the invention, the lamp is a metal halide high-intensity discharge lamp. Such a lamp is used for e.g. car headlights. In most cases, coatings, such as chromium coatings for the feedthrough foils, are inadequate because these foils quickly corrode by exposure of the chromium to the halides within the vessel. Silicon dioxide coatings are used frequently. Molybdenum alloys with a rhenium quantity between 0.01 and 5% by weight, preferably more than 0.05 but less than 2% by weight or 1.5% by weight are less sensitive to corrosion by the halides than pure molybdenum foils or molybdenum-yttrium oxide foils, while application of e.g. a silicon dioxide coating may be omitted.

In an embodiment of the invention, the lamp component is a molybdenum alloy internal support wire of a halogen lamp. Deformability of such a support wire is relevant for processing so as to obtain adequate shapes of these wires. In particular, rhenium and/or zirconium constituents in quantities as specified in claim 6 have been found to yield support wires of sufficient ductility. Moreover, these constituents are adequate getters of harmful impurities, such as oxygen, carbon and hydrogen originating from other parts of the lamp including the halogen filling of the vessel, the tungsten filament and the vessel itself. Zirconium especially absorbs water. These alloys may again also be used for feedthrough foils of the halogen lamp. The benefits of using the claimed molybdenum alloys for the lamp components include the prevention of blackening of molybdenum wires, e.g. a support wire, resulting from halogen attack and molybdenum transport during burning. Furthermore, the presence of one or more impurity getters within the vessel limits the destructive effects of impurities on the tungsten filament of a halogen lamp. The advantageous effects improve the overall service life of the halogen lamp.

In order to improve the oxidation resistance of the outer current conductors, these may be coated with e.g. chromium, because these conductors are not exposed to the internal lamp atmosphere. Furthermore, a phosphate acid treatment of a lamp component, such as the molybdenum foil, may improve the oxidation and corrosion resistance.

The invention also relates to a method of manufacturing a lamp component, such as a feedthrough element, an outer current conductor and an inner current conductor, the method comprising the step of shaping said lamp component from a molybdenum alloy having at least one constituent from the group formed by rhenium and chromium in a quantity between 0.01 and 5% by weight; titanium in a quantity between 0.01 and 0.1% by weight; aluminum, cobalt, gadolinium, hafnium, iridium, iron and zirconium in a quantity between 0.01 and 1% by weight of said alloy.

The invention also relates to a method of manufacturing a lamp, comprising the step of applying a lamp component manufactured by means of the method described in the preceding paragraph.

The invention will be further illustrated with reference to the attached drawings, which schematically show preferred embodiments according to the invention. It will be understood that the invention is not in any way limited to these specific and preferred embodiments.

### BRIEF DESCRIPTION OF THE DRAWINGS

In the drawings:

FIG. 1 is a cross-sectional view of a metal halide high-intensity discharge lamp for a car headlight according to an embodiment of the invention;

FIG. 2 depicts measurement results of oxidation experiments performed on foils;

FIG. 3 depicts the homogeneous elongation of different foils annealed at 2000° C.;

FIG. 4 depicts the elongation of a molybdenum-rhenium foil annealed at different temperatures, and

FIG. 5 shows a portion of a halogen lamp according to an embodiment of the invention.

### DESCRIPTION OF EMBODIMENTS

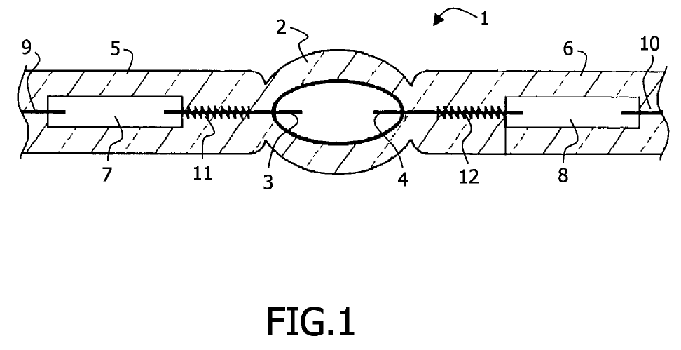

FIG. 1 shows a structure of a 35 W metal halide discharge lamp 1 for a car headlight according to an embodiment of the invention. A vessel 2 of the lamp 1 is made of quartz, and electrodes 3 and 4 made of a pair of tungsten bars are provided at both ends. Foils 7 and 8 are sealed hermetically in sealing end parts 5 and 6 of the vessel 2, and a rear end of the tungsten electrode 3 is welded and connected to one end of the foil 7, while a rear end of the tungsten electrode 4 is welded and connected to one end of the foil 8. Outer current conductors 9 and 10 are welded and connected to the other ends of the foils 7 and 8, respectively. In this case, tungsten coils 11 and 12 serving as buffer members are wound around the sealed portions of the tungsten electrodes 3 and 4 in the sealing end parts 5 and 6 of the envelope. It is to be noted that, instead of winding the tungsten coils 11 and 12 around the sealed portions of the tungsten electrodes 3 and 4 in the sealing end parts of the envelope, rhenium, platinum, rhodium, ruthenium, gold, or the like may be coated thereon.

The foils 7, 8 are molybdenum-rhenium alloys comprising 0.9% by weight of rhenium and 0.3% by weight of yttrium oxide. Accelerated lifetime measurements in a furnace at 475° C. of these foils yielded an increase of the average lifetime of the foils by a factor of 3.5 as compared with conventional molybdenum foils with yttrium oxide. Furthermore, observation of the foils in metal halide xenon lamps yielded a significant reduction of the attack by the gases within the vessel 2 as compared with conventional molybdenum foils with yttrium oxide.

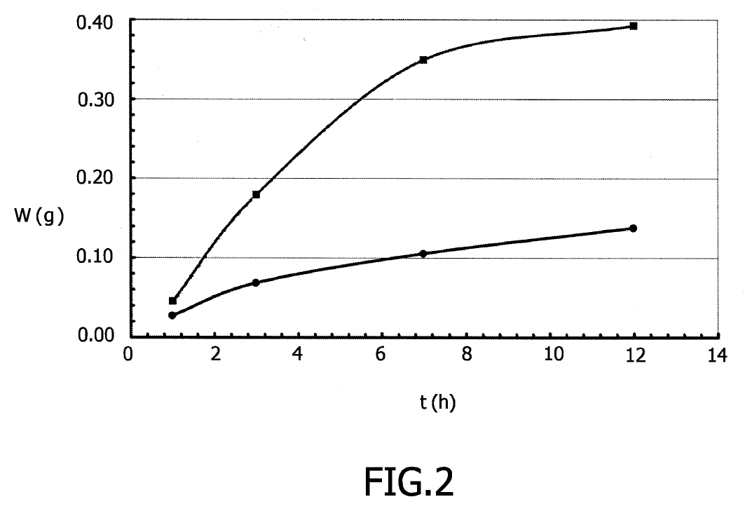

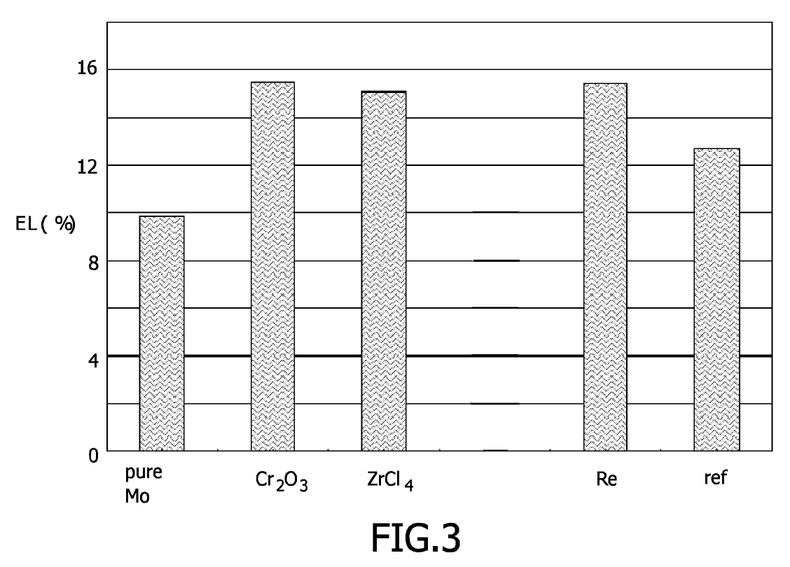

FIG. 2 depicts the results of oxidation experiments performed on bare foils at a temperature of 600° C. Clearly, the weight gain W of the conventional molybdenum foils with yttrium oxide (upper curve) increases drastically with time t, while the weight gain W of the molybdenum-rhenium foil with yttrium oxide (lower curve) according to the invention is considerably less. In time, oxygen atoms are captured by rhenium and prevent the formation of volatile molybdenum oxides to reduce the probability of leakage from the vessel 2. FIG. 3 depicts the homogeneous elongation EL of a variety of foils annealed at a temperature of 2000° C. Clearly, doping of the molybdenum foil with Cr₂O₃, ZrCl₄ or Re increases the maximum homogeneous elongation of the molybdenum alloy foils. The first bar from the left indicates pure molybdenum without any intentionally added dopant, the second bar indicates molybdenum doped with 0.3% by weight of Y₂O₃ and 0.4% by weight of Cr₂O₃, the third bar indicates molybdenum doped with 0.3% by weight of Y₂O₃ and 1.21% by weight of ZrCl₄, the fourth bar indicates molybdenum doped with 0.3% by weight of Y₂O₃ and 0.97% by weight of Re and the fifth bar indicates molybdenum doped with 0.65% by weight of Y₂O₃ as a reference.

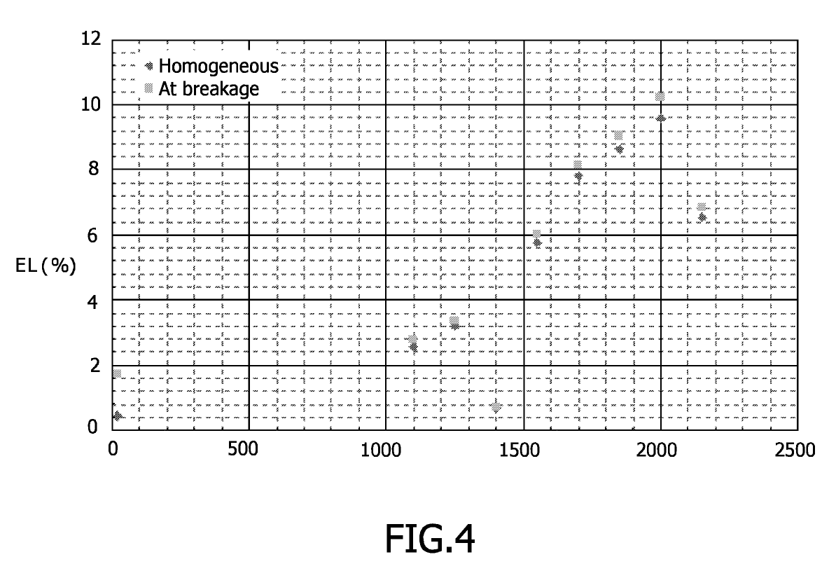

FIG. 4 depicts elongation EL measurement results of electrolytically etched and annealed molybdenum alloy foils containing 0.3% by weight of Y₂O₃ and 0.97% by weight of Re at different annealing temperatures. The elongation EL increases with the annealing temperature and reaches a maximum for an annealing temperature of approximately 2000° C.

It should be noted that other molybdenum alloy components can be envisaged for lamps using one or more of the constituents and quantities defined in claim 1.

For example, the outer current conductors 9, 10 shown in FIG. 1 may be made of the molybdenum alloys according to the invention.

The invention is applicable to a variety of lamps, including ultrahigh-pressure lamps (UHP) and automotive lamps.

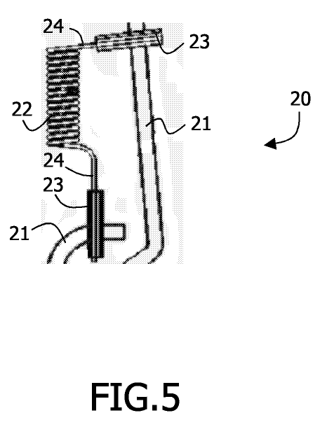

FIG. 5 shows a portion of a halogen lamp 20 according to an embodiment of the invention, wherein current-conveying support wires 21 support a tungsten filament 22 via molybdenum sleeves 23 and a molybdenum mandrel 24. The support wires 21 may comprise a molybdenum-rhenium alloy or a molybdenum-zirconium alloy according to an embodiment of the invention. It is noted that the molybdenum alloy support wire does not contain yttrium oxide or a combination of yttrium oxide and cerium oxide as described above for the molybdenum alloy foils. The claimed quantities of said rhenium and/or zirconium constituents allow an appropriate balance between the ductility performance (relevant for shaping of the support wire) and the getter function for harmful impurities.

In the claims, any reference signs placed between parentheses shall not be construed as limiting the claim. Use of the verb “comprise” and its conjugations does not exclude the presence of elements or steps other than those stated in a claim. Use of the indefinite article “a” or “an” preceding an element does not exclude the presence of a plurality of such elements. The mere fact that certain measures are recited in mutually different dependent claims does not indicate that a combination of these measures cannot be used to advantage.

1. A lamp (1;20) comprising a gastight vessel (2) embedding one or more feedthrough elements (7,8) electrically interconnecting an outer current conductor (9,10) and an inner current conductor (3,4;21) for operating said lamp, wherein at least one of said feedthrough elements, said outer current conductor and said inner current conductor is a molybdenum alloy component containing at least one constituent from the group formed by rhenium and chromium in a quantity between 0.01 and 5% by weight; titanium in a quantity between 0.01 and 0.1% by weight; and aluminum, cobalt, gadolinium, hafnium, iridium, iron and zirconium in a quantity between 0.01 and 1% by weight of said alloy.

2. The lamp (1;20) according to claim 1, wherein said gastight vessel (2) is a quartz glass vessel with one or more pinched seals (5,6) embedding molybdenum alloy foils (7,8) as said feedthrough elements.

3. The lamp (1;20) according to claim 2, wherein said constituent is rhenium in a quantity of less than 2% by weight, preferably less than 1.5% by weight.

4. The lamp (1) according to claim 1, wherein said lamp is a metal halide high-intensity discharge lamp.

5. The lamp (20) according to claim 1, wherein said lamp is a halogen lamp comprising a molybdenum alloy internal support wire (21).

6. The lamp (20) according to claim 5, wherein said constituent is rhenium in a quantity of less than 2% by weight or zirconium in a quantity of less than 1% by weight.

7. The lamp (1;20) according to claim 1, wherein said outer current conductor has a chromium coating.

8. The lamp (1;20) according to claim 1, wherein said feedthrough element is a phosphate acid-treated element.

9. A method of manufacturing a lamp component, such as a feedthrough element (7,8), an outer current conductor (9,10) and an inner current conductor (3,4;21), the method comprising the step of shaping said lamp component from a molybdenum alloy having at least one constituent from the group formed by rhenium and chromium in a quantity between 0.01 and 5% by weight; titanium in a quantity between 0.01 and 0.1% by weight; and aluminum, cobalt, gadolinium, hafnium, iridium, iron and zirconium in a quantity between 0.01 and 1% by weight of said alloy.

10. A method of manufacturing a lamp (1;20), comprising the step of applying a lamp component manufactured by means of the method according to claim 9.
